(19) United States
(12) Patent Application Publication
(10) Pub. No.: US 2007/0003289 A1
(43) Pub. Date: Jan. 4, 2007

(54) Integrated infrared transceiver

(76) Inventors: Wee-Sin Tan, Singapore (SG); Raymond Quek, Loveland, CO (US)

Correspondence Address: AVAGO TECHNOLOGIES, LTD., P.O. BOX 1920, DENVER, CO, 80201-1920, US

(21) Appl. No.: 11/174,151

(22) Filed: Jun. 30, 2005

(51) Int. Cl. H04B 10/00

(52) U.S. Cl. 398/164; 398/135

(57) ABSTRACT

In one embodiment, apparatus is provided with a substrate on which a photosensor and a light source are mounted. The photosensor is configured to receive light in an optical band about a wavelength of 940 nanometers; and the light source is configured to transmit light in an optical band about a wavelength of 940 nanometers. Circuitry that is physically supported by the substrate, and that is electrically coupled to the photosensor and the light source, terminates in electrical contacts that are physically supported by the substrate. Other embodiments are also disclosed.

### BACKGROUND

Infrared (IR) remote controllers are so popular nowadays that they are ubiquitous in the living rooms of the world. Conventionally, IR transmitters are built into remote controllers, and IR receivers are built into electrical appliances (such as audio systems (e.g., stereo receivers), audio-video systems (e.g., televisions), and household control systems (e.g., cooling/heating thermostats, light switches, fan switches and alarm systems)). In this manner, a user may use a remote controller to send commands to one or more targeted systems.

In some applications, interactive operation between two or more devices is desirable. For example, interactive communication between two personal digital assistants (PDAs) may be desirable. In these applications, both of the devices involved in a communication session must be provided with transmitting and receiving capabilities. Often, the amount of data to be transmitted between the devices is relatively small. However, the distances over which the devices may need to transmit the data may be relatively long (e.g., over one meter).

The communication distance supported by Infrared Data Association (IrDA®) standards is only one meter. Thus, although products such as the Agilent HSDL-3002 (a product distributed by Agilent Technologies, Inc.) provide an integrated IrDA transceiver, such products are generally not useful in longer distance interactive applications. Radio frequency (RF) standards, such as Bluetooth®, may be used in longer distance interactive applications. However, RF solutions can be costly and are subject to electromagnetic interference.

### SUMMARY OF THE INVENTION

In one embodiment, apparatus comprises a substrate on which a photosensor and a light source are mounted. The photosensor is configured to receive light in an optical band about a wavelength of 940 nanometers; and the light source is configured to transmit light in an optical band about a wavelength of 940 nanometers. Circuitry that is physically supported by the substrate, and that is electrically coupled to the photosensor and the light source, terminates in electrical contacts that are physically supported by the substrate.

In another embodiment, an interactive communication system comprises at least two devices that are configured to communicate with each other. At least a first of the devices is configured to communicate with at least one other of the devices via an integrated transceiver. The integrated transceiver comprises a substrate on which a photosensor and a light source are mounted. The photosensor is configured to receive light from the at least one other of the devices, in an optical band about a wavelength of 940 nanometers. The light source is configured to transmit light to the at least one other of the devices, in an optical band about a wavelength of 940 nanometers. Circuitry that is physically supported by the substrate, and that is electrically coupled to the photosensor and the light source, terminates in electrical contacts that are physically supported by the substrate.

Other embodiments are also disclosed.

### BRIEF DESCRIPTION OF THE DRAWINGS

Illustrative embodiments of the invention are illustrated in the drawings, in which:

FIG. 1 illustrates a perspective view of an exemplary embodiment of an integrated IR transceiver in which a photosensor and a light source are mounted to a common substrate and configured to receive and transmit light in an optical band about a wavelength of 940 nanometers;

FIG. 2 illustrates a plan view of the substrate and circuitry of the FIG. 1 transceiver;

FIG. 3 illustrates a first exemplary embodiment of the IC controller shown in FIG. 1;

FIG. 4 illustrates a second exemplary embodiment of the IC controller shown in FIG. 1;

FIG. 5 illustrates an exemplary mounting of the FIG. 1 transceiver within a handheld device;

FIG. 6 illustrates the use of the device shown in FIG. 5 as a handheld game machine that communicates with another handheld game machine;

FIG. 7 illustrates the use of the device shown in FIG. 5 as handheld game machine that communicates with a central game controller; and

FIG. 8 illustrates the use of the device shown in FIG. 5 as a household controller.

### DETAILED DESCRIPTION

IrDA transceivers operate in an optical band about a wavelength of 870 nanometers (nm), which band is preferably centered on, and substantially limited to, the 870 nm wavelength. In contrast, IR remote controllers and receivers operate in an optical band about a wavelength of 940 nm, which band is preferably centered on, and substantially limited to, the 940 nm wavelength. In addition, IR remote control receivers typically use larger chip size photodiodes as compared to IrDA receivers. As a result of their larger photodiodes, and other factors, IR remote control receivers tend to have sensitivities on the order of ten times the sensitivities of IrDA receivers. This, in turn, enables IR remote control operations to be conducted over distances that are approximately ten times the one meter communication distance supported by the IrDA standard. However, IR remote controllers have conventionally been used for the one-way transmission of simple commands, and not for interactive communications.

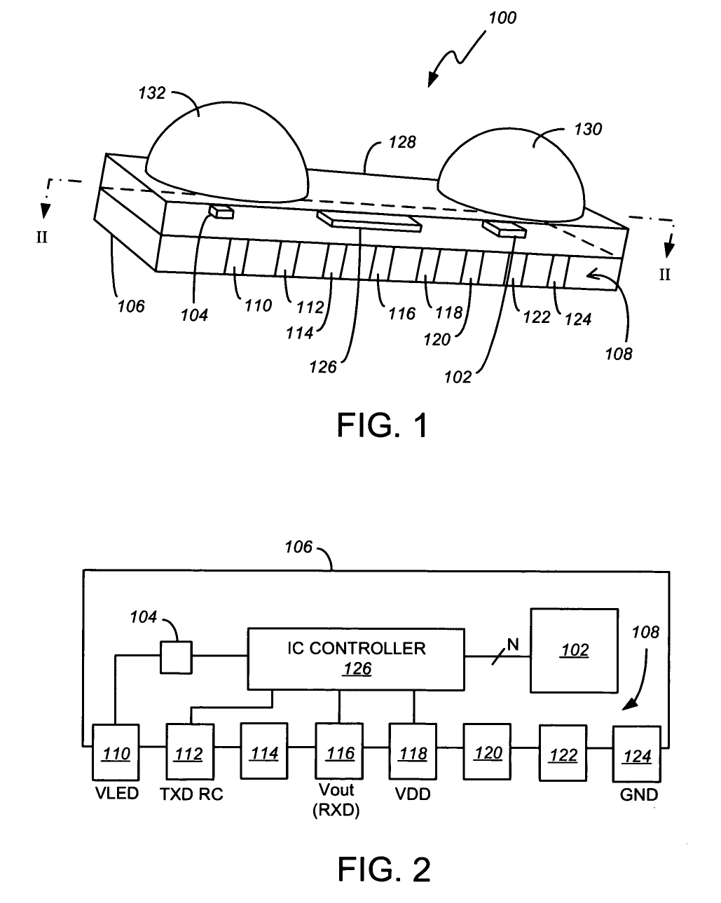

To combine interactive communication functionality, such as that which is supported by the IrDA standard, with the longer operating range and sensitivity of IR remote controllers and receivers, the inventors propose an integrated IR transceiver 100 in which a photosensor 102 and a light source 104 are mounted to a common substrate 106 and configured to receive and transmit light in an optical band about a wavelength of 940 nanometers. FIGS. 1 & 2 illustrate an exemplary embodiment of such a transceiver 100. FIG. 1 illustrates a perspective view of the transceiver 100; and FIG. 2 illustrates a plan view of the substrate 106 and circuitry 108 of the transceiver 100.

By way of example, the substrate 106 shown in FIGS. 1 & 2 is a printed circuit board (PCB). However, the substrate 106 could alternately take other forms, such as polymer or ceramic. Mounted to the substrate 106 is a photosensor 102 that is configured to receive light in an optical band about a wavelength of 940 nm. Preferably, the band is centered on, and substantially limited to, the 940 nm wavelength. By “substantially limited to”, it is meant that a deviation from the 940 nm wavelength of ±30 nm is preferred. In one embodiment, the photosensor 102 is a photodiode chip. However, the photosensor 102 could alternately take other forms, such as that of a phototransistor.

A light source 104 is also mounted to the substrate 106. The light source 104 is configured to transmit light in an optical band about a wavelength of 940 nm. Similarly to the band in which the photosensor operates, the band in which the light source 104 operates is preferably centered on, and substantially limited to, the 940 nm wavelength. Again, by “substantially limited to”, it is meant that a deviation from the 940 nm wavelength of ±30 nm is preferred. In one embodiment, the light source 104 is a light emitting diode (LED) chip. However, the light source 104 could alternately take other forms, such as that of a laser diode.

The photosensor 102 and light source 104 may be mounted to the substrate 106 in various ways, such as by solder or adhesive.

In addition to the photosensor 102 and light source 104, the substrate 106 supports (i.e., physically supports) other circuitry 108 that is electrically coupled to the photosensor 102 and the light source 104. At a minimum, this circuitry 108 comprises electrical contacts 110, 112,114,116, 118,120,122, 124 to which devices that use the integrated transceiver 100 may be electrically coupled. Optionally, the circuitry 108 may comprise an integrated circuit (IC) controller 126.

FIG. 2 illustrates an exemplary plan view of the substrate 106 and circuitry 108 of the transceiver 100. Although an exemplary circuit trace and electrical contact pattern are shown, the particular components 102, 104, 126 that are mounted on the substrate 106 may dictate a need for an alternate circuit trace and electrical contact pattern. By way of example, the electrical contacts 110-124 are shown to comprise an LED supply voltage (VLED), a “transmit data” input (TXD RC), a “received data” output (Vout (RXD)), a controller supply voltage (VDD), and a transceiver ground input (GND).

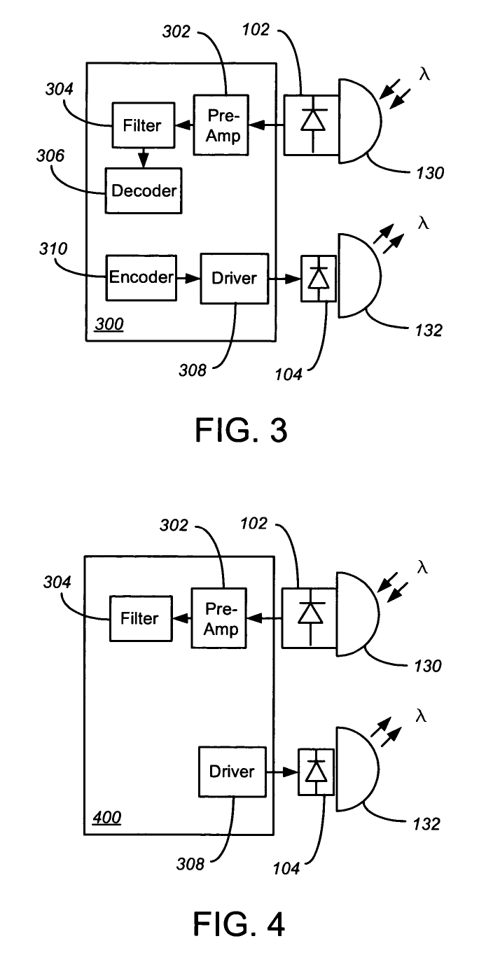

FIG. 3 illustrates a first exemplary embodiment 300 of the IC controller 126. In this embodiment, the IC controller 300 comprises a preamp 302, a filter 304 and a decoder 306, all of which are coupled between the photosensor 102 and the electrical contacts 110-124. In one embodiment, the preamp 302 has an adjustable gain and serves to amplify received IR signals to distinguishable levels; the filter 304 serves to eliminate noise and/or certain signal frequencies; and the decoder 306 serves to extract discrete digital data streams from received IR signals. The IC controller 300 further comprises a driver circuit 308 and an encoder 310, both of which are coupled between the light source 104 and the electrical contacts 110-124. In one embodiment, the encoder 310 serves to modulate digital data streams for transmission by the light source 104; and the driver circuit 308 serves to control the current or other operating parameters of the light source 104 so as to convert the modulated digital data streams to optical data streams.

FIG. 4 illustrates a second exemplary embodiment 400 of the IC controller 126 shown in FIG. 1. This embodiment 400 is similar to the embodiment 300 shown in FIG. 3, but for the elimination of the encoder 310 and decoder 306. In some embodiments, it may be useful to move the encoder 310 and decoder 306 to a separate IC, so as to enable a wider range of applications for the integrated IR transceiver 100.

The IC controller 126 may be mounted to the substrate 106 in various ways. For example, if the circuitry 108 comprises traces that are electrically coupled to the photosensor 102, the light source 104 and the electrical contacts 110-124, the IC controller 126 may be coupled to the traces via wire bonds, or via a flip chip mounting method.

In lieu of the IC controller 126, some or all of the components 202-210 thereof may be individually mounted on the substrate 106. However, this would increase the number of steps required to manufacture the transceiver 100, and is therefore believed to be less desirable than using the IC controller 126.

As shown in FIG. 1, an optically translucent encapsulant 128, such as an epoxy compound, may cover the photosensor 102, light source 104 and IC controller 126. In some cases, the encapsulant 128 may be used to filter received or transmitted light. For example, the encapsulant 128 could be chosen such that it serves as a bandpass filter centered at or about 940 nm. In this manner, shorter light wavelengths (e.g., visible light) can be filtered out so as to make the transceiver 100 more immune to sunlight, fluorescent light, tungsten light, and other stray light. Similarly, longer light wavelengths can be filtered out so as to mitigate any undesirable effects that they might have on the transceiver 100.

As also shown in FIG. 1, first and second lenses 130,132 may be respectively positioned in optical transmission paths of the photosensor 102 and the light source 104. The lens 130 positioned adjacent the photosensor 102 may serve to focus received light on the photosensor 102. The lens 132 positioned adjacent the light source 104 may re-shape the light radiation profile of the light source 104 so as to provide a useful radiation profile for IR communications.

In one embodiment, the first and second lenses 130,132 are molded into the encapsulant 128.

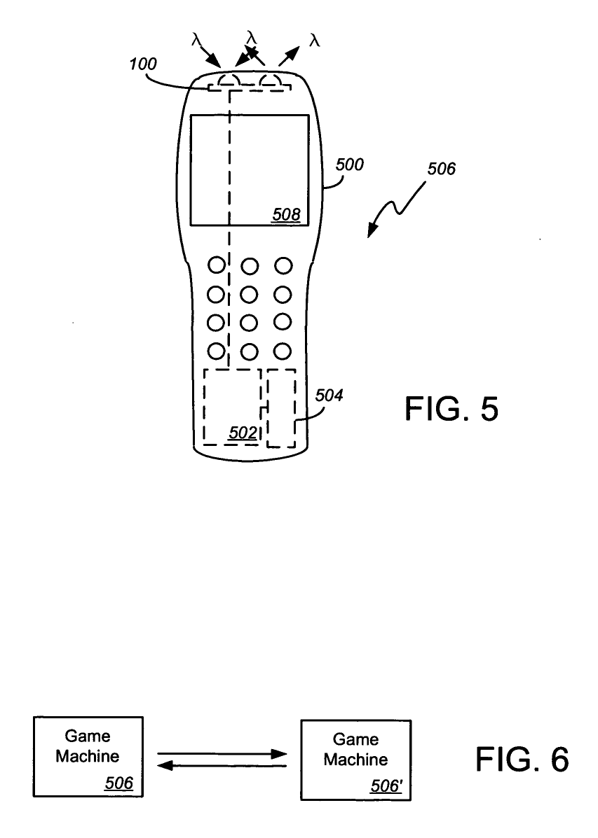

The integrated IR transceiver 100 that is disclosed herein has many applications. For example, and as shown in FIG. 5, the transceiver 100 may be mounted within a handheld device housing 500, with its photosensor 102 and light source 104 being optically exposed to the exterior of the housing 500. A microprocessor 502 and memory 504 may also be mounted within the housing 500, with the microprocessor 502 being electrically coupled to both the memory 504 and the transceiver 100. In this manner, the microprocessor 502 may 1) retrieve and execute instructions stored in the memory 504, and 2) communicate with a device external to the housing 500.

In one embodiment, the handheld apparatus 506 shown in FIG. 5 may be an interactive game machine, with the instructions stored in the memory 504 defining a game program. In this embodiment, a user of the game machine 506 may exchange game status with the user of another handheld game machine 506′ (see FIG. 6). Note that the exemplary game machine 506 is shown with an optional display 508. By transmitting game status using the transceiver 100, and not using an IrDA transceiver, handheld game machines 506, 506′ can be designed to communicate with each other over longer distances. This can be especially useful for outdoor game play, game play on a train, or game play in shopping centers or restaurants. Alternately, a handheld game machine 506, 506′ configured as shown in FIG. 5 may be used to communicate with a central game controller 700 (see FIG. 7).

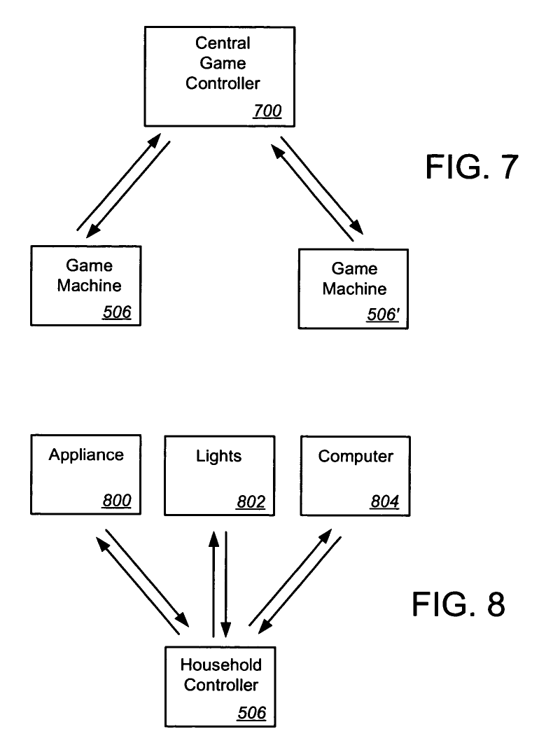

In another embodiment, the handheld apparatus 506 shown in FIG. 5 may be a household controller (see FIG. 8). In this embodiment, for example, appliances 800, switches (e.g., lights 802) and other home systems (e.g., a computer 804) may be both 1) controlled, and 2) polled for their status. The statuses of the home systems may then be displayed to a user.

In addition to the above-mentioned handheld devices, the integrated IR transceiver 100 disclosed herein may be incorporated into other handheld devices (e.g., phones and PDAs), as well as stationary and semi-stationary devices (e.g., interactive televisions and home appliances).

What is claimed is:

1. Apparatus, comprising:
a substrate;
a photosensor mounted on the substrate, the photosensor being configured to receive light in an optical band about a wavelength of 940 nanometers;
a light source mounted on the substrate, the light source being configured to transmit light in an optical band about a wavelength of 940 nanometers; and
circuitry that is physically supported by the substrate and electrically coupled to the photosensor and the light source, the circuitry terminating in electrical contacts that are physically supported by the substrate.

2. The apparatus of claim 1, wherein the photosensor is a photodiode chip.

3. The apparatus of claim 1, wherein the light source is a light emitting diode (LED) chip.

4. The apparatus of claim 1, wherein the light source is a laser diode.

5. The apparatus of claim 1, wherein the substrate is a printed circuit board (PCB).

6. The apparatus of claim 1, further comprising an optically translucent encapsulant covering at least the photosensor and the light source.

7. The apparatus of claim 1, wherein the optically translucent encapsulant comprises an epoxy compound.

8. The apparatus of claim 6, further comprising first and second lenses, respectively molded into the encapsulant above the photosensor and the light source.

9. The apparatus of claim 1, further comprising first and second lenses, respectively positioned in optical transmission paths of the photosensor and the light source.

10. The apparatus of claim 1, wherein the circuitry comprises an integrated circuit (IC) controller.

11. The apparatus of claim 10, wherein the circuitry further comprises:
traces that are electrically coupled to the photosensor, the light source and the electrical contacts; and
wire bonds that couple the IC controller to the traces.

12. The apparatus of claim 10, wherein the circuitry further comprises traces on the PCB that are electrically coupled to the photosensor, the light source and the electrical contacts; and wherein the IC controller is flip chip mounted to the traces.

13. The apparatus of claim 10, wherein the IC controller comprises:
a preamp and a filter, coupled between the photosensor and the electrical contacts; and
a driver circuit, coupled between the light source and the electrical contacts.

14. The apparatus of claim 13, wherein the IC controller further comprises:
a decoder, coupled between the filter and the electrical contacts; and
an encoder, coupled between the driver circuit and the electrical contacts.

15. The apparatus of claim 10, further comprising an optically translucent encapsulant covering at least the photosensor, the light source and the IC controller.

16. The apparatus of claim 15, further comprising first and second lenses, respectively positioned in optical transmission paths of the photosensor and the light source.

17. The apparatus of claim 16, wherein the photosensor is a photodiode; and wherein the light source is a light emitting diode (LED).

18. The apparatus of claim 1, further comprising a handheld device housing, the substrate being mounted within the handheld device housing with the photosensor and light source being optically exposed to an exterior of the handheld device housing.

19. The apparatus of claim 18, further comprising a microprocessor and a memory, both mounted within the handheld device housing, wherein the microprocessor is electrically coupled to the memory to retrieve and execute instructions stored therein, and wherein the microprocessor is electrically coupled to the photosensor and light source to communicate with a device external to the handheld device housing.

20. The apparatus of claim 19, wherein the instructions stored in the memory define a game program.

21. Apparatus, comprising:
a printed circuit board (PCB);
means, mounted to the PCB, to receive light in an optical band about a wavelength of 940 nanometers; and
means, mounted to the PCB, to transmit light in an optical band about a wavelength of 940 nanometers.

22. An interactive communication system, comprising:
at least two devices that are configured to communicate with each other, with at least a first of the devices being configured to communicate with at least one other of the devices via an integrated transceiver, the integrated transceiver comprising:
a substrate;
a photosensor mounted on the substrate, the photosensor being configured to receive light from the at least one other of the devices, in an optical band about a wavelength of 940 nanometers;
a light source mounted on the substrate, the light source being configured to transmit light to the at least one other of the devices, in an optical band about a wavelength of 940 nanometers; and
circuitry that is physically supported by the substrate and electrically coupled to the photosensor and the light source, the circuitry terminating in electrical contacts that are physically supported by the substrate.

23. The system of claim 22, wherein the first of the devices is a handheld game machine.

24. The system of claim 22, wherein the first of the devices is a household controller.
